(19) United States
(12) Patent Application Publication
(10) Pub. No.: US 2008/0022347 A1
(43) Pub. Date: Jan. 24, 2008

(54) TV-on-demand

(76) Inventor: Noam Cohen, Binyamina (IL)

Correspondence Address: PEARL COHEN ZEDEK LATZER, LLP, 1500 BROADWAY 12TH FLOOR, NEW YORK, NY, 10036, US

(21) Appl. No.: 11/480,567

(22) Filed: Jul. 5, 2006

(51) Int. Cl. H04N 7/173; H04N 7/16

(52) U.S. Cl. 725/134; 725/142; 725/89

(57) ABSTRACT

A TV-on-demand method comprising recording the broadcasted data stream in consecutive segments of information and using the recorded segments in TV-on-demand applications.

### FIELD OF THE INVENTION

The present invention relates to video streaming. More particularly it relates to a TV-on-demand technique and applications.

### BACKGROUND OF THE INVENTION

Personal Video Recording (PVR) devices, either standalone ones (e.g. TiVO® available from TiVO Inc., Alviso, Calif., USA) or high-end Set-Top-Boxes (STB) with a hard-disk drive and recording capabilities, are gaining increased popularity. One of the main reasons is probably related to the fact that easy to use user interfaces, never seen on their analog counterparts—the VCRs—allow users to easily request recordings without the need to set the recording time, or adjust the system clock. Another reason is the emergence of new applications that were not available in the traditional VCR model, such as “Pause live TV”.

If to take the concept one step further, the trend of separating content availability from the traditional dictated broadcast schedule, often dubbed as TV on-demand (TVOD), is predicted to be very appealing to subscribers, and to open a world of possibilities to the operator leveraging on the existing or newly deployed network and video infrastructure.

The TVOD technology of the present invention enables service providers and operators to implement video recording applications over the network, offering various flavors of service packages and advanced consumer applications. The use of recording technology performed in the server side, together with the ability to scale up and stream hundreds of streams to subscribers, allows the operators to implement new revenue generating applications, most of which are not possible to implement with a client side PVR device. By “client” is meant the hardware located at the viewer's end (STB), as opposed to the hardware at the service provider's end.

The following “TVOD Applications” and application flavors can be considered examples of a different approach to improving subscriber experience.

Classic Personal Video Recorders (PVR) and Network PVR (NPVR): This application allows subscribers to record a program or a movie in advance, for later viewing. Ordering the recording is typically done in the Electronic Program Guide (EPG), and the ordered recording is available for the subscriber on “My recordings” list.

Unlike client-side PVRs, a network-side implementation allows greater flexibility for recording programs on different channels that are aired at the same time, and offers virtually unlimited storage quota, based on the fact that the same copies may be used by multiple subscribers.

Instant Recording: Another variation of PVR application is “instant recording”, where subscriber start and stop a recording event regardless of the EPG programming. This application appeals to a more general audience and is considered a powerful enhancement to the TV viewing experience.

This application is typically offered by the client side PVRs and obviously, in the old VCR solution, however when implemented in the server side, can be used in a common scenario of recording one channel and viewing another.

Pause Live TV (PLTV).

This application, originating from consumer PVRs allows subscribers to “pause” or “rewind” a live broadcast by switching seamlessly to a recorded session. Tile psychological effect behind this is that the user is less tightly bound to the broadcasts schedule and can take a short break, or replay a missed event. When planning a network based PLTV service, special consideration has to be given to the placing of cache seltzers so that low latency is provided when shifting to “on-Demand” and a high peak of concurrent streams needs to be supported.

Evidently, ail advantage to a server side implementation over a client side one is the guarantied ability to rewind up to a predetermined number of minutes at any time, even if the user has just zapped to the channel.

Program Restart: A variation on the PLTV application, gaining significant interest is “Program Restart” (recently launched as pilot by Time Warner under the name “Start Over”). This application enables subscribers watching live TV to restart playing the current program from the beginning in an “on Demand” mode while the program is being aired. A possible “twist” to this application is the blocking of fast forward/rewind once the program has been restarted (although trickplay, that is playback at speed which is not the normal speed, is certainly possible from the technological perspective, as the program is streamed on demand). This makes the application “advertiser friendly”, as the subscribers cannot fast forward during commercial breaks. In fact, this application “stretches” a 1-hour program slot over a 1:59 hours period, and potentially increases the exposure to Ads by the subscriber audience. As with its close counterpart, PLTV, the “program restart” application is more appealing to content providers, as content is not permanently stored for later viewing, rather it is being “cached” for one or a predetermined number of hours.

From the subscriber's point of view, “Program Restart” is intuitive and user friendly Oust “click the green button” to restart the program) and does not pose a “paradigm shift” from traditional consumption habits of broadcast TV. This positions “program restart” as a prime candidate for enriching the subscriber experience by TVOD applications, to be followed by more applications.

Time Shifted TV (TSTV)/Last X Days TV. This application allows subscribers to backtrack through the EPG for viewing programs that were already aired in the last few days. For example, a recording of the last 24 hours, or even the entire “last 7 days TV” can be available for subscribers who missed the scheduled broadcast time of their favorite show, and now can gain access to that program on-demand.

It is evident that such application is considerably more intuitive than the classic PVR There is no need to plan ahead as the advanced functionality is provided within the same well-known EPG screen with the users just having to “go back in time”. Given the easy-to-use nature of TSTV, there is a growing industry acceptance that such a service will dramatically increase the amount of on-demand sessions on account of live TV sessions. The numbers may go up to 50% concurrency at peak times, with a possible service penetration of anything between 30% and 100%, depending on the business offering of the service provider.

As opposed to NPVR and PLTV, which can be implemented as client-side solutions with certain limitations, this type of application, as well as the next one, can only be available in a network-side implementation, due to the fact that multiple programs are recorded at the same time on different channels, and the storage capacity requirement is substantial. Note: the term “TSTV” is sometimes mentioned as a “Pause live TV” application, rather than backtracking the EPG.

TV on Demand (TVOD): “TV on Demand” entails a new concept, rather than being a specific TV application, and is partly manifested in TSTV, except that it extends the experience by offering the same continuously recorded content, in a category based, personalized base, or any classification chosen by the operator. The effective meaning is that content is completely separated from the original broadcast time, and can be organized in ways that will increase consumption by subscribers, adhering to their needs rather than to a strict timeline. The operator may choose to categorize the recorded programs by genre such as comedy, sports and news. This sort of categorization is popular in VOD listings. An alternative idea may be the categorization by content provider/network brand such as “HBO series” or, “Hallmark movies”. This type of categorization will aggregate several channels into a single branded category. More elaborate examples of the possibilities are “My TV” which is user-specified classification organized in the form of a “favorite list” and classification by popularity such as “top 10 programs” etc.

Similarly to its counterpart, TSTV, this type of application can only be implemented using server side technology.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 illustrates a time line representing a channel of video multicast stream, incremented to a series of consecutive increments, according to a preferred embodiment of the present invention.

FIG. 2 is a diagram illustrating Time Shift TV implementation according to a preferred embodiment of the present invention.

FIG. 3 illustrates data buffering in PLTV STB, assuming the content of the multicast receive buffer is not available to the switching module.

FIG. 4 illustrates data buffering PLTV STB, assuming the content of the multicast receive buffer is available to the switching module.

FIG. 5 illustrates a typical system for implementation of TV on demand, according to some preferred embodiments of the present invention.

### DETAILED DESCRIPTION OF PREFERRED EMBODIMENTS

The technology disclosed in the present invention employs a unique approach to recording and storing broadcast content, to ensure high availability of the service and accuracy of recorded programming. The innovative approach simplifies the interface with the IPTV application and the integration with the EPG, while allowing immediate viewing of recorded content ordered by the subscribers. TVOD technology supports a centralized as well as distributed recording model, thus allowing the service provider to choose the best scheme according to network, storage and programming availability constraints. TVOD applications and application flavors can be implemented using the same infrastructure and the same technology. This provides flexibility to the operator in implementing different applications and experimenting with different business models, without the need to reinvest in capital expenditure for every new application. While the method and system of the present invention are best implemented by a service provider, these may also be implemented on the client side.

We now go to describe a system of digital video streaming, combining both recorded and live material.

TV on demand refers to a set of applications for TV viewers. As mentioned hereinabove, some of the applications include:

1) Time Shifted TV (TSTV). In this application, the viewer browses an Electronic Program Guide (EPG) and selects a program that has already finished. Recorded programs are kept on the operator's premises (on his servers) for a certain time (known as “moving window”) and then replaced by newer content.

2) Pause Live TV (PLTV). In this application the viewer watches a live transmission. At a certain time he presses the Pause button or Rewind button on the TV remote control. From now on, the user watches a unicast stream. (The live event is transmitted in multicast mode (broadcast).

3) Program Restart is a variation of PLTV, but requires less viewer education. The viewer simply presses a button on the remote control and the TV program restarts.

4) Network Personal Video Recorder (nPVR). In this application, the viewer browses the EPG and marks which TV programs should be recorded for him. The operator records the programs on behalf of all the viewers (typically on his servers).

The underlying technology needed to implement these applications comprises Video-On-Demand (VOD) transmitter and receivers, recording facilities of live program material, user interface, user Management, content management, and authorization, authentication and accounting systems.

There are several aspects to the invention, described here in different parts.

The common technology enabler for the applications described above is the recording mechanism. A Recording server is configured by a Management system to receive a set of incoming audio/video streams. These data streams are commonly TV programs transmitted over IP infrastructure to subscribers, but the concept is valid for other transmission infrastructures as well.

According to a preferred embodiment of the present invention, the Recording Server saves the incoming data stream in a series of data files, each of them of predetermined length (e.g. 15 minutes, half hour, one hour or so, see FIG. 1). In the example shown in FIG. 1, program A starts some time between 02:00 and 02:15 and ends at a time between 03:00 and 03:15, program B then starts ending some time between 03:45 and 04:00 where program C starts, ending some time between 04:15 and 04:30.

The separation of data to different files is not necessarily related to the content of the programs. In other words, a program may be saved in more than one recorded file. See FIG. 1, where an event—a program—spans and is saved in increments, the start of the program located at a certain time in the first file, and the end of the program located at a certain time in a different file. For the purpose of the present invention the definition of the term “event” is as defined by Digital Video Broadcasting—DVB, a consortium of over 270 broadcasters, manufacturers, network operators, software developers, regulatory bodies and others in over 35 countries (in ETSI 400-368. 2003-05) that is: grouping of elementary broadcast data streams with a defined start and end time belonging to a common service, e.g. first half of a football match, News Flash, first part of an entertainment show, etc.

Each TV channel is recorded to a separate series of consecutive files. The amount of storage used by the recoded files is determined by the operator: For Example, the operator may configure the system to keep the last 48 hours for a selected set of 5 channels. Older files are preferably deleted automatically by the management system.

This method of storing old broadcasts is easier to administer than older method in which programs were recorded in separate files, as in the latter case special attention had to be given to start recording these programs on time and end on time. In the present invention the old programs are stored in files regardless their start and end times.

EPG information includes program start and end times, but in many cases the actual start and end times do not coincide with the EPG times due to various reasons, such as live broadcasts turning longer than expected, technical problems and other reasons. Service providers employ human operators who mark the beginning and end times of programs. These marks can be used in conjunction with the service according to the present invention, so that correct start and end times are known and used properly. The marks themselves may be stored on the same files (using for example the known standard SCTE-35).

Time Shifted Live TV (TSTV).Wheni a viewer requests a program for viewing (e.g. to watch a program ordered using the Time Shifted TV EPG), the server sends to the viewer the relevant parts of the recorded material and makes sure the viewing boundaries are correct for the program. In compliance with standard URL, syntax, this is achieved with the command rtsp://server name/mc=&st&et. This is a command that plays a certain stored “mc” file from a specified start time to a specified end time, “mc” stands for “multicast”, “st” stands for the start time of a requested program and “et” stands for the end time of the requested program. In commonly available VOD services the command used is rtsp://server ip/file name mpg, which plays an entire file. The present command takes the start time and the end time and plays the files in which the requested program was saved, starting from the start time and ending at the end time. Files older than the predetermined time window (e.g. three days recording) are being deleted to free memory space for newer files.

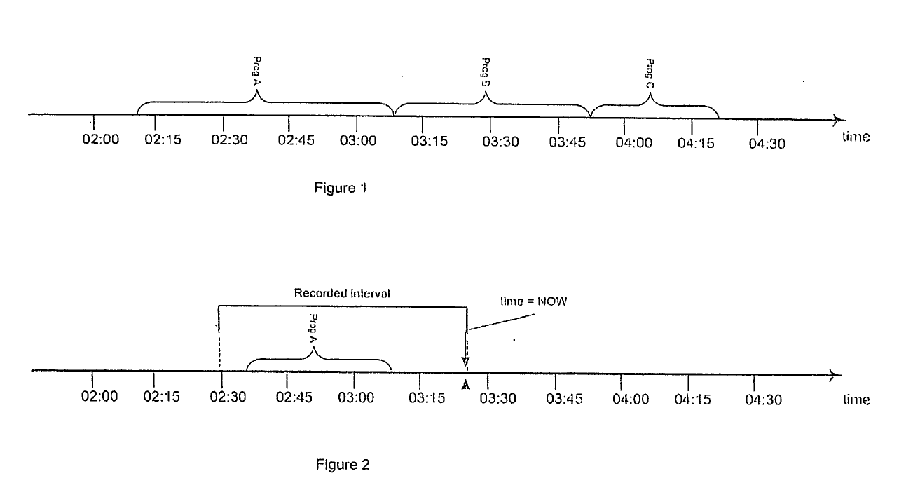

See, for example, FIG. 2 that illustrates the TSTV novel concept, according to a preferred embodiment of the present invention. The recording server records a file every 15 minutes. At a present time (03:25) a viewer wishes to view a program he has just missed, that ended some time earlier. That particular TV program had started at 02:40 with duration of 30 minutes (ending at 03: 10). The Viewer's terminal sends a request to the playout server, asking for the specific channel and start/end times, thus effectively shifting back in time to view the program that was previously aired. The Playout server (having its content prepared by the Recording Server) transmits data from the file of 02:30-02:45 from the middle and, transparently to the viewer, continues the transmission to the consecutive 2 files. When arriving to the data recorded for 03:10, the playout server sends (to the viewer's terminal) an End Of Stream notification, even though the recorded file is not at end. The playout server also imposes the limit of start time: a viewer performing rewind operation will get a “Start Of stream” notification when trying to play content earlier than 4:30 pm (in other words, he will not be allowed to view earlier recorded material on that file).

The recording server and playout server may be implemented in the same machine, as one application, or as two separate applications.

The VOD service provider records several or all of his offered channels in the manner described hereinabove (in files of substantially equal time increments) and keeps them saved for viewers wishing to “rewind” their program back in time for a predetermined period, which depends on the memory resources of the service provider or on other parameters. This is the “time window” whose duration is the time allowed for the viewers to “rewind”. As time passes by so does the time window move forwards, trailing behind the current broadcasts and advancing with time.

The viewer may zap through channels ends up watching a program he is interested in, but missed its beginning. He can choose to view the program from the beginning by selecting this option using a menu offered or by pressing a button on his remote control device. When the system identifies this selection, the video stream played at that viewer's TV set through the multicast transmission it receives is replaced by a unicast transmission from the VOD service provider's server. The viewer can choose any time in the past to start his personal viewing, provided that time is within the predetermined time window. In a preferred embodiment of the present invention if the viewer wishes to view from a time that is earlier than the current time window allows he is refused or allowed to view only from the current far end of the time window.

The invention of the present invention offers real network Personal Video Recording (nPVR) facilities.

Some VOD applications that can be offered using the method of the present invention may include:

Choosing a desired program on the EPG, saving the chosen program on a “My recordings” list available from the VOD service menu, and choosing from that list (actual start and end times need be used).

Quick restart by pressing a button or choosing this option from a menu, resulting in playing back the program from its beginning (provided it is within the time window). It is possible to provide the end time (whether or not that end time has actually arrived) and end that data stream when getting to the information recorded at the end time, or alternatively, only the start time is indicated and then the viewer experiences a delayed TV channel viewing, without event boundaries.

The present invention makes multiple recording of the same program unnecessary (if more than one viewer requests recording of a certain program) as all programs are recorded continuously.

Pause Live TV (PLTV). The nature of PLTV—pausing the picture at a certain moment in time and then carrying on playing from that frozen moment—requires real-time transition from multicast (broadcast) to unicast transmission. This requires that the recording location in the distribution network is near to the terminal, that is to say there are no noticeable delays differences between sending commands from the terminal and carrying them out by the playout server. If the recording is done on the service provider servers at a central location and then distributed, the delay in transition might be too long.

To facilitate a smooth transition from multicast to unicast, the terminal network stack parses the incoming stream (e.g. MPEG-2 Transport Stream) and requests the video server for the exact byte stream location. After receiving the start of the byte stream (of the unicast transmission), the terminal code assembles a continuous byte stream. This processing allows for smooth transition from multicast to pause and to unicast Play.

FIG. 3 shows how to change from multicast to unicast if the multicast buffer is not accessible by the software component which performs the transition from multicast to unicast.

The solution is based on getting two values from the multicast receive buffer—by an Application Program Interface (API) implemented by the STB vendor.

When changing from multicast to unicast, there is already some data buffered in the MPEG decoder internal buffer 1. The new unicast data has to be contiguous to it.

The multicast buffer 2 reports the value of the oldest Program Clock Reference (PCR) (value nearest to the values already sent to the MPEG decoder), called here PCR₀, and the byte offset of the packet, which contains the PCR from the head of the buffer, called here L.

The MPEG stream contains time tags (PCR) in regular intervals (marked ‘3’ in the figure). Note: The head of the buffer contains the byte which is immediately following the data already in the MPEG decoder.

The unicast player asks the streamer for data starting at PCR₀—ΔT, where ΔT is bigger than the maximum time between successive PCR values. The MPEG standard requires the maximal time between two successive PCR values to be less than 100 mSec, so ΔT can be set to 120 mSec. The time ‘ΔT’ is proportional to a number of bytes, marked M in the figure. The exact value of M is not important since it is guaranteed to be large enough so that PCR₀ is found in the new data buffer.

The video streamer sends the data 4 to the client and the client puts it in a temporary buffer 5. During receiving the client searches for PCR₀.

When it is found, the client returns L bytes backward and starts feeding the MPEG decoder from this position. Bytes prior to this position are discarded. The streamer keeps on sending data to the client. Using this method, a seamless connection is made possible

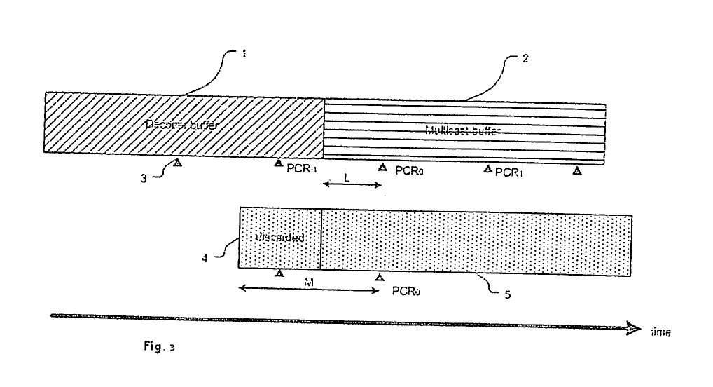

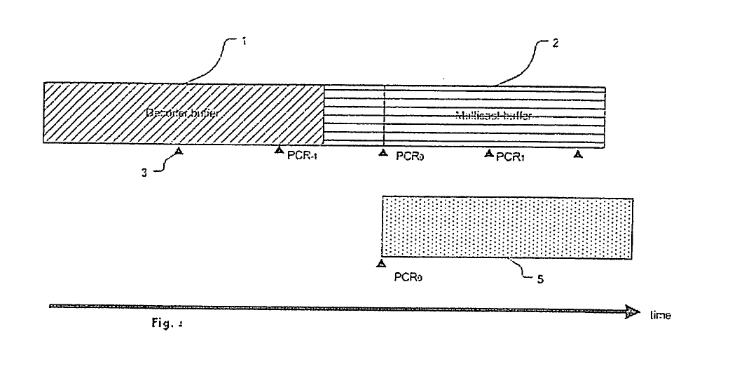

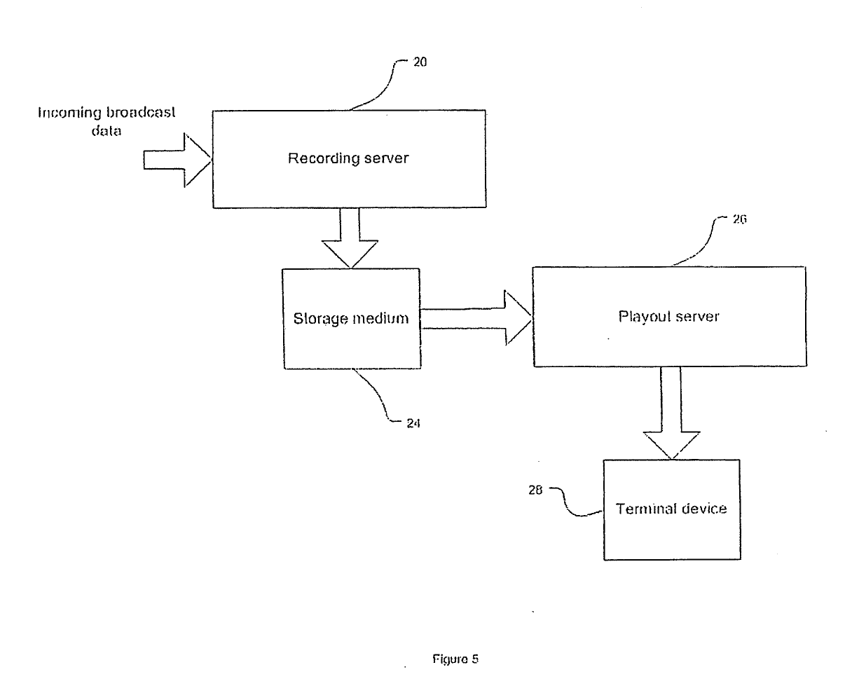

If the received multicast data buffer can be accessed directly, as shown in FIG. 4, the seamless transition between the multicast and the unicast is a little different. The terminal (STB) searches and find the first PCR (PCR₀) in the buffer 2. It then requests the video streamer to send data starting at this time value. The received (unicast) data is then sent to the decoder immediately after the data already present in the multicast buffer 2 up to the PCR₀ Data in this buffer which belong to later time than PCR₀ is discarded, since it is already present in the buffer 5 received from the streamer.

FIG. 5 illustrates a typical system for implementation of TV on demand, according to some preferred embodiments of the present invention. A recording server 20 receives incoming multicast (or unicast) broadcast data stream 22. Storage medium 24 is used to record all or selected channels in segments, in the manner described hereinabove. Playout server 26 is used to play selected data stream in TV on-demand mode, according to some preferred embodiments of the present invention to terminal device 28 (the client side) according to commands received from that terminal device.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A method for recording a broadcasted channel of data stream, the method comprising recording the broadcasted data stream in consecutive segments of information.

2. A method as claimed in claim 1, wherein the consecutive segments of information comprise segments of equal durations.

3. A method as claimed in claim 1, wherein the data stream comprises video stream.

4. A method as claimed in claim 3, wherein the video stream comprises MPEG.

5. A method as claimed in claim 1, further comprising receiving from a client a start time playing out information stream from the segments of information, starting from the start time.

6. A method as claimed in claim 5, wherein the start time is a start time of an event.

7. A method as claimed in claim 5, further comprising receiving an end time and playing out the information stream from the segments of information, starting from the start time and ending at the end time.

8. A method as claimed in claim 7, wherein the start time and the end time are start time and end times of an event.

9. A method as claimed in claim 1, further comprising after a pause command is issued by a client at a pause time followed by a resume command, playing the data stream from the paused time from the recorded segments.

10. A method as claimed in claim 9, wherein playing the data from the paused time comprises a seamless transition between a paused data instant.

11. A method as claimed in claim 10, wherein the data stream includes time tags, and wherein the seamless transition is achieved by locating a time tag after the paused time, requesting and receiving data from a playout server starting from the time tag, and playing a contiguous data stream comprising data previously stored on a local buffer and seamlessly continuing to data received from the playout server.

12. A method as claimed in claim 1, implemented on one or more servers of a service provider.

13. A method as claimed in claim 1, implemented on one or more servers of a client.

14. A system for data streaming comprising a recording server for recording a broadcasted data stream in consecutive segments of information.

15. A system as claimed in claim 14, further comprising a playout server for playing out one or more data streams from the recorded segments of information.
